(19) United States
(12) Patent Application Publication
(10) Pub. No.: US 2014/0376418 A1
(43) Pub. Date: Dec. 25, 2014

(54) ENHANCED MODULATOR AND DEMODULATOR

(71) Applicant: Raja BANERJEA, San Jose, CA (US)

(72) Inventor: Raja BANERJEA, San Jose, CA (US)

(21) Appl. No.: 13/927,107

(22) Filed: Jun. 25, 2013

(51) Int. Cl. H04B 7/015; H04B 10/61; H04B 10/524; H04B 7/04; H04L 5/14; H04B 10/54

(52) U.S. Cl. CPC H04B 7/015; H04L 5/14; H04B 10/541; H04B 10/524; H04B 7/0413; H04B 7/0452; H04B 10/612
USPC 370/278; 375/295; 375/316; 375/298; 375/242; 375/267; 370/329; 375/320

(57) ABSTRACT

Embodiments of this invention describe a method to reduce the effective inter carrier spacing between the sub-carriers of wireless, wired or optical transmissions and thereby increase the spectral efficiency of the communication system. Signal transmitted from multiple transmit chains are shifted in frequency at the transmitter. At the receiver a plurality of receive chains is used, the received signals are similarly shifted in frequency and used to reduce the inter carrier interference. Embodiments also describe a method for Full Duplex communication where the transmitters transmit using different frequency shifts. The receiver receives the transmitted signal and an echo of it's transmission. As the received transmission is shifted in frequency from it's transmission, it can cancel out the echo and receive the intended signal.

### FIELD

The embodiments pertain to wireless communication systems. Some embodiments pertain to OFDM systems. Some embodiments pertain to Full-duplex wireless communication. Some embodiments pertain to IEEE 802.11 standard. Some embodiments pertain to 3GPP and LTE standards.

### BACKGROUND

Wireless Networks have evolved rapidly over the past two decades. Wireless LAN networks as described by the IEEE 802.11 specification has evolved from 1 Mbps to 11 Mbps, 54 Mbps, 200 Mbps and now 1 Gbps. This evolution has allowed the user to surf the internet, share content with others and share media in the home between devices. Cellular networks have also evolved over the past two decades from GSM, EDGE, 3G and now LTE. The evolution of the cellular network has allowed the consumers to stay always connected with devices which can surf the internet, download maps etc. and get information from the World Wide Web anywhere.

However with the rapid growth of these mobile devices and consumers using these devices more frequently, the cellular network is unable to keep up with the consumer demand. Rapid advances in cellular technology from GSM to OFDM based LTE has allowed the operators to increase the efficiency measured in bits/sec/Hz of these networks. Operators have also purchased more spectrums and increased the deployment of LTE.

Thus there exists a need to increase the spectral efficiency of wireless transmissions; this is achieved through the use of enhanced modulations schemes proposed.

### SUMMARY

Wireless communication systems are used to transmit data from one wireless modem, the wireless transmitter, to the other wireless modem, the wireless receiver. When OFDM is used to transmit data the subcarriers are by design orthogonal therefore limiting the inter carrier interference. Embodiments describe a transmit mechanism to reduce the inter carrier spacing between the carriers and a method to therefore increase the spectral efficiency of the wireless system. Multiple transmit chains are used and the signal from the various transmit chains are shifted in frequency at the transmitter and then transmitted. Embodiments also describe a receive mechanism which includes a plurality of wireless receive chains which shift the received data in frequency and cancel out the inter carrier interference.

Wireless communication systems typically are not full duplex. Embodiments describe a transmit mechanism for Full Duplex wireless communication which includes a Wireless Modem which includes a wireless transmitter and a wireless receiver. The wireless modem communicates to a plurality of other wireless modems. Wireless transmitter transmits using OFDM. Other Wireless modems also simultaneously transmit using OFDM on a shifted set of sub carriers. The wireless receiver receives the transmitted signal from other wireless modems and an echo of it's wireless transmission. As the received signal is shifted in frequency from its wireless transmission, it can cancel out the echo and receive the wireless signal.

These methods can also be used for wired and optical communication.

### DESCRIPTION OF DRAWINGS

FIG. 1 illustrates a mobile wireless system including a mobile wireless transmitter and mobile wireless receivers.

FIG. 2 illustrates a wireless local area network system including a wireless transmitter and wireless receivers.

FIG. 3 illustrates the Access Point and Client.

FIG. 4 describes the modulator flow for a coded OFDM system.

FIG. 5 describes the de-modulator flow for a coded OFDM System.

FIG. 6 illustrates the transmit flow for a coded OFDM system using the Enhanced modulator.

FIG. 7 illustrates the mechanism of shifting carriers and combining them.

FIG. 8 illustrates another instantiation of the transmit flow for a coded OFDM system using the Enhanced modulator.

FIG. 9 describes the receive flow for a coded OFDM system using the Enhanced modulator.

FIG. 10 describes the Quadrature Amplitude Modulator.

FIG. 11 illustrates simplified receiver architecture for the enhanced OFDM receiver.

FIG. 12 illustrates another instantiation of the enhanced OFDM system.

FIG. 13 describes another instantiation of the receiver for an enhanced OFDM system.

FIG. 14 illustrates another instantiation of the enhanced OFDM system where a single power amplifier is used to transmit the signal.

FIG. 15 illustrates another instantiation of the enhanced OFDM system where pulse code modulation is as a constellation mapper.

FIG. 16 describes the PCM modulator for one bit, 2 bit, 3 bit and 4 bit mapper.

FIG. 17 describes the receive flow for an enhanced OFDM system using the PCM system.

FIG. 18 illustrates the enhanced OFDM system using PCM Modulator where a single power amplifier is used to transmit the signal.

FIG. 19 illustrates the enhanced OFDM system when used with a MIMO system.

FIG. 20 illustrates the enhanced OFDM system when used a Multi-user MIMO system.

FIG. 21 shows the 802.11a preamble.

FIG. 22 shows the 802.11n mixed mode preamble.

FIG. 23 shows the 802.11ac preamble.

FIG. 24 describes the enhanced modulator preamble.

FIG. 25 describes the transmit flow for the SVHT PLCP.

FIG. 26 describes the receive flow for the SVHT PLCP.

FIG. 27 describes a mechanism where the transmit frequency shift is achieved in the frequency domain.

FIG. 28 describes a mechanism where receive frequency shift is achieved in the time domain.

FIG. 29 illustrates a Full Duplex Wireless modem using frequency shifting.

FIG. 30 illustrates the frequency shift on the transmitter and receiver for a Full Duplex modem.

FIG. 31 illustrates the embodiment of the Full Duplex modem where the echo is removed prior to shifting of the signal in the receiver path.

FIG. 32 illustrates the embodiment of the Full Duplex modem where the frequency shift is applied on the transmitter. The leading digit(s) of each reference numeral used in this specification indicates the number of the drawing in which the reference numeral first appears.

### DETAILED DESCRIPTION

The expected network throughput in Exbytes from 2011 to 2016 shows a CAGR of 78%. This increase in demand is expected to be met using increased spectrum, smaller cells and improved spectral efficiency. The Shannon Theorem provides an upper bound for the number of bps/Hz. Table-1 compares the Shannon limit to the bps/Hz of IEEE 802.11n.

TABLE 1

| | MaxCap | 802.11n | | |
|---|---|---|---|---|
| SNR | (Mbps) | (Mbps) | N_{bps}_{_{—}}ₘₐₓ | N_{bps} |
| 1 | 15.2 | 6.5 | 1.17 | 0.5 |
| 4 | 23.6 | 13 | 1.8 | 1.0 |
| 6 | 30.1 | 19.5 | 2.3 | 1.5 |
| 9 | 41 | 26 | 3.16 | 2.0 |
| 13 | 57 | 39 | 4.37 | 3 |
| 17 | 73.8 | 52 | 5.62 | 4 |
| 18 | 78 | 58.5 | 6 | 4.5 |
| 19 | 82.3 | 65 | 6.25 | 5 |

SNR is the Signal to Noise Ratio, MaxCap is the maximum capacity from Shannon Limit, 802.11n (Mbps) is the throughput from the IEEE 802.11n specification, Nbps_max is the maximum bits per second per Hz based on the Shannon Limit, and Nbps is the bits per second per Hz as specified in the IEEE 802.11n specification. As can be seen the bits per second per Hz achieved through the IEEE 802.11n specification is lower than the maximum bits per second per Hz that could be achieved in the channel. The mechanism proposed allows reduction in the gap and reach spectral efficiency closure to the Shannon Limit.

Wireless LAN networks have continuously increased the spectrum efficiency and throughput from IEEE 802.11 (1 Mbps), to IEEE 802.11b (11 Mbps), IEEE 802.11n (200 Mbps) to IEEE 802.11ac (1-7 Gbps). This has been achieved by increasing the spectral efficiency as measurement in bits/sec/Hz using OFDM and Multiple Input Multiple Output (MIMO). Spectral efficiency as measured using bits/sec/Hz has also been increased using Multi-User MIMO.

Cellular systems have similarly increased the spectral efficiency and throughput from GSM, to CDMA-2000, to 3G and now LTE systems. Increasing the spectral efficiency allows operators to deploy new technology using existing spectrum and not having to purchase new spectrum.

Embodiments of the present disclosure enable the use of enhanced modulation and demodulation techniques to improve the link data rate. The protocol is referred to as Enhanced OFDM Modem (EOM) and the mechanism allows the wireless system to transmit more bits/sec/Hz and therefore increase the efficiency and throughput.

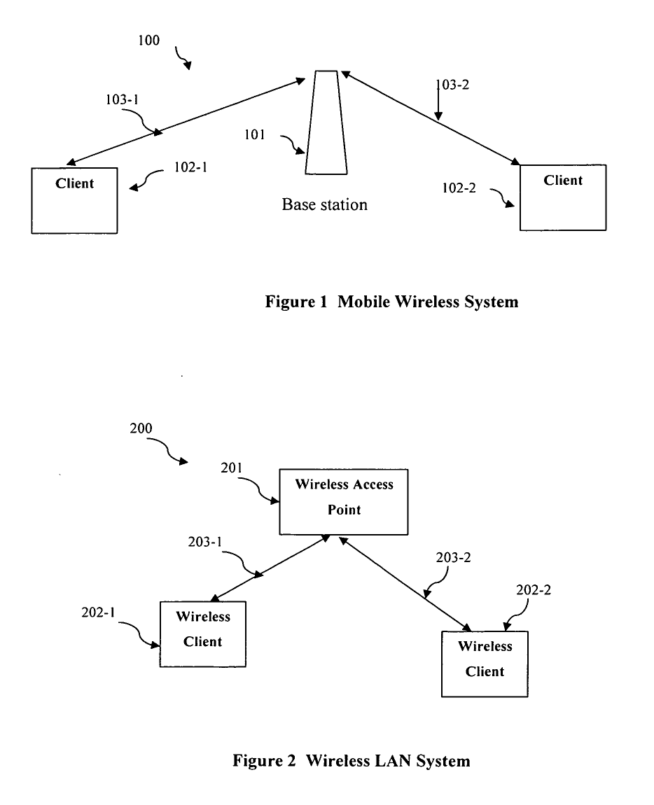

FIG. 1 shows a Mobile Wireless access system 100, which includes a Base station 101, clients 102-1 and 102-2, the wireless signal 103-1 and 103-2. Although in the described embodiments the elements of the wireless network access system 100 are presented in one arrangement, other embodiments may feature other arrangements. The base station could be a cellular, micro, femto or pico base station. The clients could be a phone, a Smartphone, tablet or laptop. In some embodiments the wireless network could also be a fixed wireless network. The data is transmitted by the base station 101 is modulated using the methods described in this application. The data received by clients 102-1 and 102-2 are demodulated using the methods described in this application. The data transmitted by the Clients 102-1 and 102-2 are described in this application. The data received by the base station 101 is described in this application.

FIG. 2 shows a Wireless Local Area Network system 200, which includes a Wireless Access Point 201, Wireless clients 202-1 and 202-2, the wireless signal 203-1 and 203-2. Although in the described embodiment the elements of the wireless LAN system 200 are presented in one arrangement, other embodiments may feature other arrangements. The Wireless Access Point 201 could be deployed for residential wireless broadband access, wireless mobile hotspot access, enterprise wireless LAN access or for sensor networks. The clients 202-1 and 202-2 could be a laptop, a Smartphone, a tablet or a sensor node. In some embodiments the wireless network could also be a fixed wireless network. The data transmitted by the Wireless Access Point 201 is modulated using the methods described in this application. The data received by Wireless clients 202-1 and 202-2 are demodulated using the methods described in this application. The data transmitted by the Wireless Clients 202-1 and 202-2 is modulated as described in this application. The data received by the Wireless Access Point 201 is described in this application.

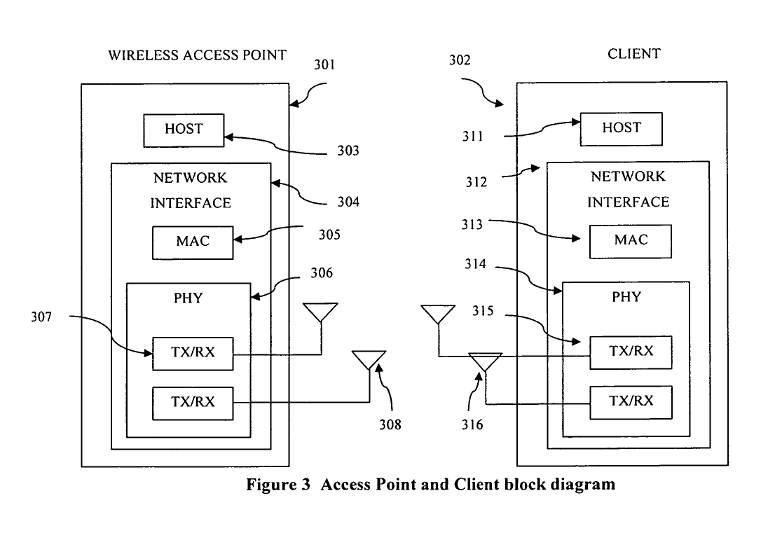

FIG. 3 shows the Wireless Access Point 301 which includes the host processor 303, the Network Interface 304 which includes the MAC 305, the PHY 306. The PHY 306 includes a plurality of transceivers 307 and the Antenna 308 which is used to transmit the wireless signal. In one embodiment the MAC and the PHY are configured to operate using the EOM protocol. In other embodiment of the MAC and PHY are configured to operate using a cellular protocol like LTE, in other embodiments the MAC and the PHY are configured to operate using the IEEE 802.11ac protocol. In yet other embodiment the MAC and the PHY are configured to operate using the IEEE 802.11a or IEEE 802.11n protocol.

The Wireless Access Point communicates to a plurality of clients. The Client is shown in 302. The client includes the host processor 311, the Network interface 312 which includes the MAC 313 and the PHY 314. The PHY includes a plurality of transceivers 315 which are connected to a plurality of Antennas 316. The wireless signal is transmitted out of the Antenna. In one embodiment the MAC and the PHY are configured to operate using the EOM protocol. In other embodiment of the MAC and PHY are configured to operate using a cellular protocol like LTE, in other embodiments the MAC and the PHY are configured to operate using the IEEE 802.11ac protocol. In yet other embodiment the MAC and the PHY are configured to operate using the IEEE 802.11a or IEEE 802.11n protocol.

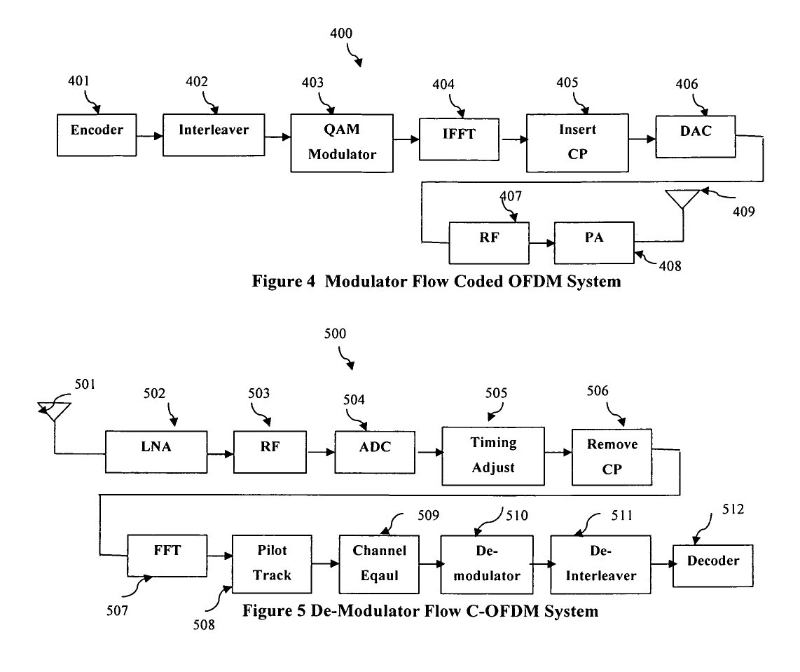

FIG. 4 shows the modulator flow of a coded OFDM system. Similar modulators are used in Wireless LAN systems using IEEE 802.11a, 802.11n and 802.11ac systems. Similar modulation techniques are also used for cellular system like LTE. The modulator 400 consists of an encoder 401 which could be a trellis encoder or a LDPC encoder or other encoder. The encoded bits are then sent to the interleaver 402. The interleaver changes the bit order such that due to noise continuous bits are not lost. The output of the interleaver is sent to the QAM modulator 403. The QAM modulator could use Gray encoding to map the bits to real and imaginary values. The real and imaginary samples are then transformed from the frequency domain to the time domain using the IFFT 404. Cyclic prefix is added to the bit stream in 405. The digital samples are then converted to analog using the Digital to Analog convertor. The baseband signal is then modulated with a carrier frequency by the RF in 407. The signal power is then boosted using the PA in 408. Finally the wireless signal is transmitted through the antenna 409.

FIG. 5 shows the de-modulator flow of a coded OFDM system. Similar de-modulators are used in IEEE 802.11a, 802.11n and 802.11ac systems. Similar de-modulation techniques are also used for cellular system like LTE. The de-modulator 500 consists of an antenna 501 which receives the wireless signal; the signal amplitude is increased by the LNA 502. The RF 503 converts the signal from the carrier frequency to baseband frequency. The ADC 504 converts the analog bits to digital; the timing adjustment module detects the start of the symbol and adjusts the timing of the ADC to match with the transmitter's frequency. The Cyclic prefix is removed by the Remove CP block 506. The FFT 507 computes the Fourier transform and converts the time domain signal to frequency domain. The Pilot Track block 508, tracks the phase of the receive pilots and adjusts the frequency of the demodulation. The channel is equalized by the Channel Equalizer 509. The demodulator 510 slices the received I/Q samples and determines the closest constellation point. The samples are then sent to the de-interleaver which reverses the sample ordering based on the interleaver. These samples are then fed to the decoder which could be a viterbi or LDPC or other decoder. The decoded bit stream is then processed by the MAC or other entity.

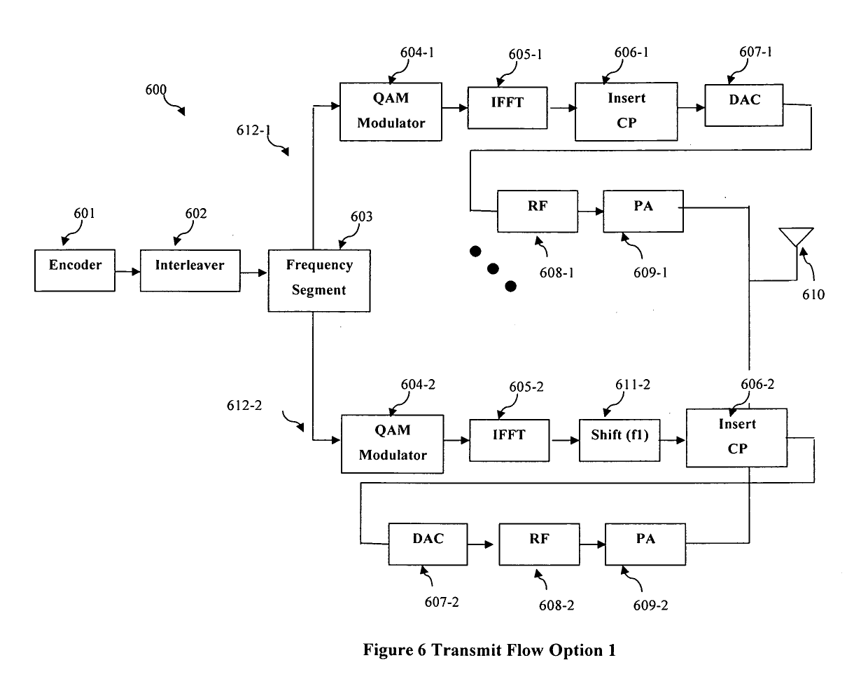

FIG. 6 shows the modulator flow of an embodiment of the enhanced OFDM modulator. The EOM 600 consists of an encoder 601 which could be a trellis encoder or a LDPC encoder or other encoder. The encoded bits are then sent to the interleaver 602. The output of the interleaver is sent to the Frequency segment 603. The Frequency segment takes interleaved bits and then maps them to the plurality of transmit chains 612. The mapping of bits to the plurality of transmit chains could be done by sending the first bit to the first transmit chain, the second bit to the second transmit chain and so on. The mapping of bits could also be done where the first ‘m1’ bits are sent to the first transmit chain, the next ‘m2’ bits are sent to the next transmit chain and so on.

Other Frequency segment parsing techniques could also be used.

Transmit chain 612-1 consists of a QAM modulator 604-1. The QAM modulator could use Gray encoding to map the bits to real and imaginary values. Typical QAM modulators are BPSK, QPSK, 16-QAM, 64-QAM and 256-QAM. Other QAM modulators could also be used. The real and imaginary samples are then transformed from the frequency domain to the time domain using the IFFT 605-1. Cyclic prefix is added to the bit stream in 606-1. The digital samples are then converted to analog using the Digital to Analog convertor 607-1. The baseband signal is then modulated with a carrier frequency by the RF in 608-1. The signal power is then boosted using the PA in 609-1. Finally the wireless signal is transmitted through the antenna 610.

Transmit chain 612-2 consists of a QAM modulator 604-2. The QAM modulator could use Gray encoding to map the bits to real and imaginary values. Typical QAM modulators are BPSK, QPSK, 16-QAM, 64-QAM and 256-QAM. Other QAM modulators could also be used. The QAM encoder used in each of the transmit chains could be different. Transmit chain 612-1 could use QAM modulator 16-QAM while transmit chain 612-2 could use QAM modulator QPSK. The real and imaginary samples are then transformed from the frequency domain to the time domain using the IFFT 605-2. The time domain samples are then shifted in frequency by 611-2. The frequency shift is done to allow transmission of multiple streams in the same bandwidth using a single antenna. Frequency shift is applied to all N chains or (N-1) chains. Cyclic prefix is added to the bit stream in 606-2. The digital samples are then converted to analog using the Digital to Analog convertor 607-2. The baseband signal is then modulated with a carrier frequency by the RF in 608-2. The signal power is then boosted using the PA in 609-2. Finally the wireless signal is transmitted through the antenna 610.

The increase in throughput comes from the reduction in subcarrier spacing due to multiple transmit chains and the increased transmit power from using multiple Power Amplifies (PA). A plurality of transmit chains can be combined.

Frequency shift allows for transmission of multiple streams in the same bandwidth. It reduces the inter carrier spacing but increases the transmission capacity. Frequency shift is applied in the time domain by multiplying the time domain samples by the exponent

$${e}^{\frac{j 2 Π mn}{N}} ,$$

where m is the shift applied in frequency, x(n) is the time domain sample n^{th} sample and N is the size of the IFFT. If X(k) is the DFT of x(n) then X(K+m) is realized in the time domain by x(n).

$${e}^{\frac{j 2 Π mn}{N}} .$$

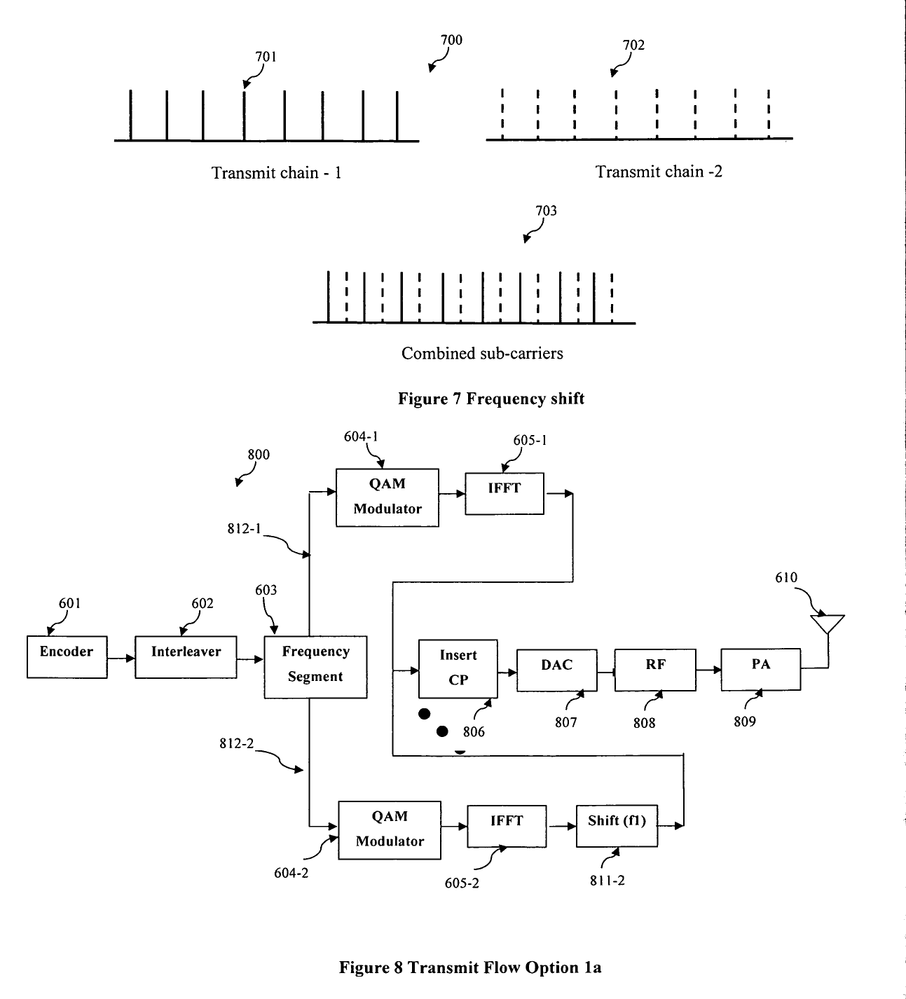

FIG. 7 describes the mechanism of combining of the subcarriers which leads to the increased throughput of EOM. The subcarriers in transmit chain one are represented by 701, the subcarriers in transmit chain two are represented in 702. The combined subcarriers obtained by adding the signals from transmit chain one and two are represented in 703. Plurality of chains can be added to achieve the combined sub-carrier realization.

FIG. 8 shows a different realization of the EOM transmitter. The EOM 800 consists of an encoder 601 which could be a trellis encoder or a LDPC encoder or other encoder. The encoded bits are then sent to the interleaver 602. The output of the interleaver is sent to the Frequency segment parser 603. The Frequency segment parser takes interleaved bits and then maps them to the plurality of transmit chains. Transmit chain 812-1 consists of a QAM modulator 604-1. The QAM modulator could use Gray encoding to map the bits to real and imaginary values. The real and imaginary samples are then transformed from the frequency domain to the time domain using the IFFT 605-1.

Transmit chain 812-2 consists of a QAM modulator 604-2. The QAM modulator could use Gray encoding to map the bits to real and imaginary values. The real and imaginary samples are then transformed from the frequency domain to the time domain using the IFFT 605-2.

The samples from transmit chains 812-1 and 812-2 are combined using addition to form one sample stream. Cyclic prefix is added to the bit stream in 806. The digital samples are then converted to analog using the Digital to Analog convertor 807. The baseband signal is then modulated with a carrier frequency by the RF in 808. The signal power is then boosted using the PA in 809. Finally the wireless signal is transmitted through the antenna 610.

The increase in throughput comes from the reduction in subcarrier spacing due to multiple transmit chains. A plurality of transmit chains can be used.

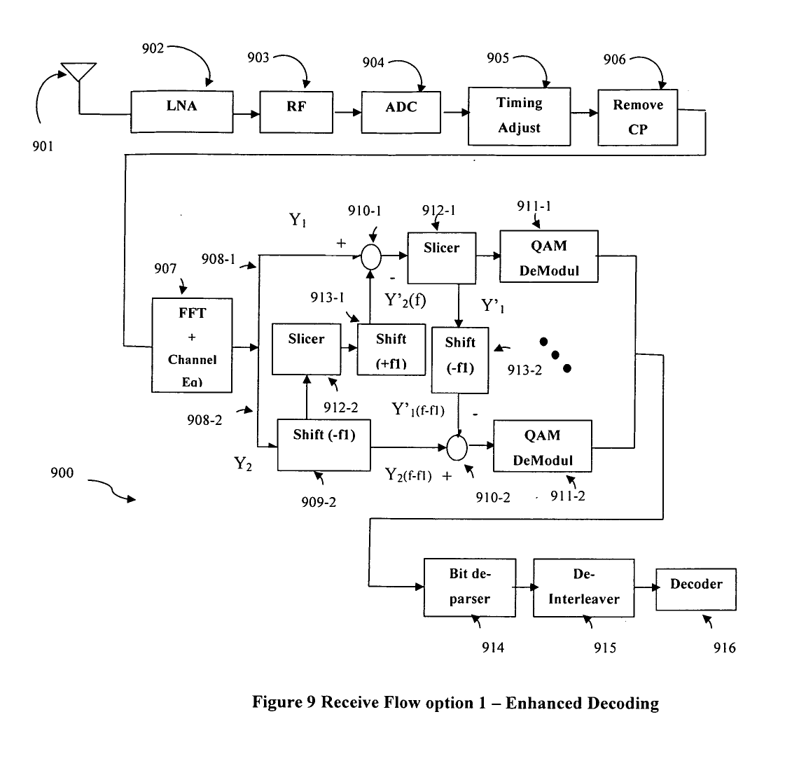

FIG. 9 describes an instance the EOM receiver. The receiver 900 consists of an antenna 901 which receives the wireless signal; the signal amplitude is increased by the LNA 902. The RF 903 converts the signal from the carrier frequency to baseband frequency. The ADC 904 converts the analog bits to digital; the timing adjustment module 905 detects the start of the symbol and adjusts the timing of the ADC to match with the transmitter's frequency. The Cyclic prefix is removed by the Remove CP block 906. The FFT 907 computes the Fourier transform and converts the time domain signal to frequency domain. The Equalizer in 907 is used to equalize the signal.

The signal is then sent to transmit chains 908-1 and 908-2. In transmit chain 908-2 the signal Y₂ is shifted by −f1 in block 909-2. This was the frequency shift applied in the transmitter on transmit chain 611-2 of FIG. 6 and 811-2 in FIG. 8. The output of 909-2 is passed to the Slicer 912-2.

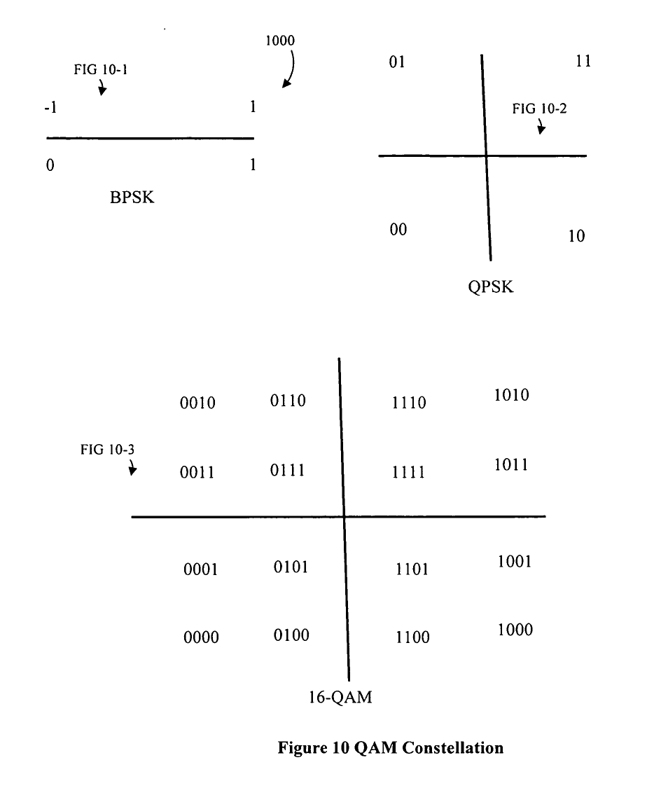

The slicer 912-2 determines the closest constellation point corresponding to the signal and outputs that value. The modulation used could be a QAM modulation in which case the slicer converts the received I/Q samples to the closest constellation point based on the modulation used (BPSK, QPSK, 16-QAM, 64-QAM etc.). Gray encoded QAM constellations are shown in FIG. 10. FIG. 10-1 shows BPSK constellation, FIG. 10-2 QPSK constellation, FIG 10-3 16-QAM constellation. The slicer 912-2 determines the closest constellation point the received signal belongs to based on minimum distance from that constellation point and outputs the I/Q value for that constellation.

The output of 912-2 is then shifted by frequency “f1” in block 913-1. The output signal Y′₂(f) is then subtracted from the signal Y₁ in transmit chain 908-1 by 910-1. The output of 910-1 is then QAM demodulated by the Slice, 912-1. The signal is then sent to the QAM-Demodulator 911-1 which converts the I/Q samples to soft bits. Soft bits represent the bit stream along with a fraction which represents the distance from the constellation point.

In transmit chain 908-2 the signal Y₂ is shifted by f1 in block 909-2. The shifted signal Y′₁(f−f1) is subtracted from Y₂(f−f1) in 910-2. This signal is then QAM demodulated by block 911-2 which converts the I/Q samples to soft bits. Soft bits represent the bit stream along with a fraction which represents the distance from the constellation point.

The signals from transmit chain 908-1 and 908-2 is then combined in the same manner as the signal was parsed into the transmit chains by the Bit de-parser 914. If a round robin mechanism was used to distribute the bits over the transmit chains, a similar round robin mechanism is used to combine the bit streams from the received chains into a single bit stream. If the Frequency Segmenter Block 603 sent “m1” bits to transmit chain 612-1 and “m2” bits to transmit chain 612-2, then block 914 also first takes “m1” bits from chain 908-1 and “m2” bits from chain 908-2.

The samples are then sent to the de-interleaver 915, which reverses the sample ordering based on the interleaver. These samples are then fed to the decoder 916 which could be a viterbi or LDPC or other decoder. The decoded bit stream is then processed by the MAC or other entity.

A plurality of received chains can be combined. The number of received chains is equal to the number of transmit chains.

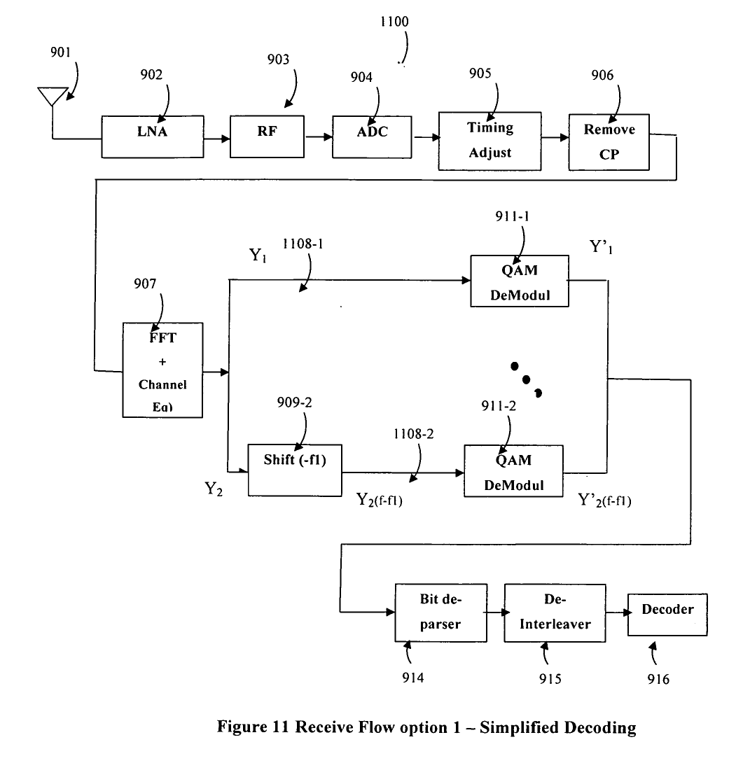

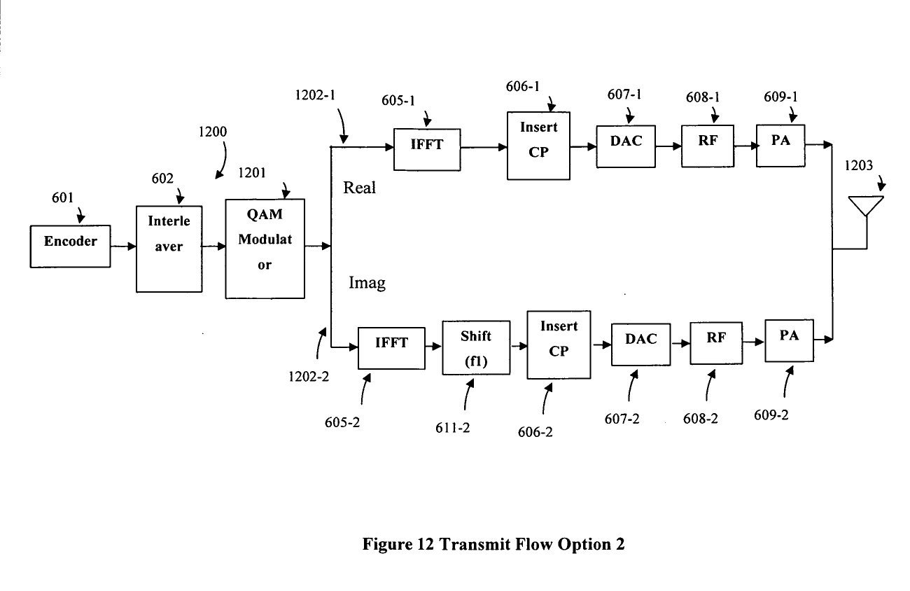

FIG. 11 describes a simplified decoder for EOM where the received signal is shift by the appropriate frequency and the QAM demodulation computed on the samples. The receiver 1100 consists of an antenna 901 which receives the wireless signal; the signal amplitude is increased by the LNA 902. The RF 903 converts the signal from the carrier frequency to baseband frequency. The ADC 904 converts the analog bits to digital; the timing adjustment module detects the start of the symbol and adjusts the timing of the ADC to match with the transmitter's frequency. The Cyclic prefix is removed by the Remove CP block 906. The FFT 907 computes the Fourier transform and converts the time domain signal to frequency domain. The Equalizer in 907 is used to equalize the signal.

The signal is then sent to transmit chains 1108-1 and 1108-2. In transmit chain 1108-1 the signal Y₁ is QAM demodulated by block 911-1 which converts the I/Q samples to soft bits. Soft bits represent the bit stream along with a fraction which represents the distance from the constellation point.

In transmit chain 1108-2 the signal Y₂ is shifted by “−f1” in block 909-2. The shifted signal Y′₂(f−f1) is then QAM demodulated by block 911-2 which converts the I/Q samples to soft bits. Soft bits represent the bit stream along with a fraction which represents the distance from the constellation point.

The signals from transmit chain 1108-1 and 1108-2 is then combined in the same manner as the signal was parsed into the transmit chains by the Bit de-parser 914. If a round robin mechanism was used to distribute the bits over the transmit chains, a similar round robin mechanism is used to combine the bit streams from the received chains into a single bit stream. If the Frequency Segmenter Block 603 sent “m1” bits to transmit chain 612-1 and “m2” bits to transmit chain 612-2, then block 914 also first takes “m1” bits from chain 908-1 and “m2” bits from chain 908-2.

Other Frequency segment parsing techniques could also be used.

The samples are then sent to the de-interleaver 915, which reverses the sample ordering based on the interleaver. These samples are then fed to the decoder 916 which could be a viterbi or LDPC or other decoder. The decoded bit stream is then processed by the MAC or other entity.

A plurality of received chains can be combined. The number of received chains is equal to the number of transmit chains.

FIG. 12 describes an instantiation of the EOM modulator where the real and imaginary values obtained from the QAM modulator are transmitted over two chains. The imaginary value is shifted in frequency by “f1” to reduce the inter carrier spacing of the signal. The signal is encoded in 601, interleaved in 602 and then sent to the QAM modulator. One type of QAM modulator using Gray encoding of signals is described in FIG. 10. The Real samples obtained from the QAM modulator is sent over transmit chain 1202-1 and the imaginary values obtained the QAM modulator is sent over transmit chain 1202-2.

In transmit chain 1202-1, The IFFT of the signal is computed in 605-1, Cyclic Prefix added in 606-1, the digital samples converted to analogue in 607-1. The RF block, 608-1 modulates the signal to the RF carrier frequency and the PA, 609-1 increases the signal gain.

In transmit chain 1202-2, The IFFT of the signal is computed in 605-2, the signal is shifted by frequency “f1” by 611-2, Cyclic Prefix added in 606-2, the digital samples converted to analogue in 607-2. The RF block, 608-2 modulates the signal to the RF carrier frequency and the PA, 609-2 increases the signal gain.

The signal from transmit chain 1202-1 and 1202-2 are combined and then transmitted out of antenna 1203.

In other instances transmit chain 1201-1 could be used to receive the imaginary samples and 1201-2 could be used to receive the real samples.

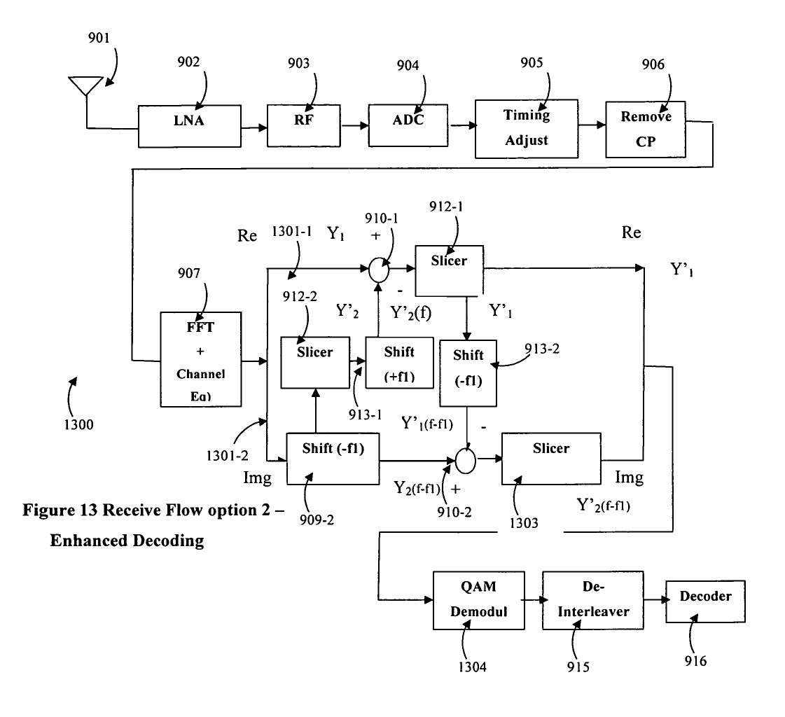

FIG. 13 describes another instance of the EOM receiver which is used to receive signals from EOM transmitter 1200. The EOM receiver 1300 consists of an antenna 901 which receives the wireless signal; the signal amplitude is increased by the LNA 902. The RF 903 converts the signal from the carrier frequency to baseband frequency. The ADC 904 converts the analog bits to digital; the timing adjustment module detects the start of the symbol and adjusts the timing of the ADC to match with the transmitter's frequency. The Cyclic prefix is removed by the Remove CP block 906. The FFT 907 computes the Fourier transform and converts the time domain signal to frequency domain. The Equalizer in 907 is used to equalize the signal.

The signal is then sent to receive chains 1301-1 and 1301-2. In receive chain 1301-2 the signal Y₂ is shifted by “−f1” in block 909-2. This was the frequency shift applied in the transmitter. The output of 909-2 is passed to the Slicer 912-2.

The slicer 912-2 determines the closest constellation point corresponding to the signal and outputs that value. If QAM modulation is used at the transmitter, the slicer converts the received I/Q samples to the closest co-ordinates based on the modulation used (BPSK, QPSK, 16-QAM, 64-QAM etc.). The slicer 912-2 determines the closest constellation point the received signal belongs to based on minimum distance from that constellation point and outputs the I/Q value for that constellation.

The output of 912-2 is then shifted by frequency “f1” in block 913-1. The output signal Y′₂(f) is then subtracted from the signal Y₁ in transmit chain 1301-1 by 910-1. The output of 910-1 is then QAM demodulated by the Slice, 912-1.

In receive chain 1301-2 the signal Y₂ is shifted by −f1 in block 909-2. The shifted signal Y′₁(f−f1) is subtracted from Y₂(f−f1) in 910-2. The slicer 1303 determines the closest constellation point corresponding to the signal and outputs that value. The modulation used could be a QAM modulation in which case the slicer converts the received I/Q samples to the closest co-ordinates based on the modulation used (BPSK, QPSK, 16-QAM, 64-QAM etc.).

The samples from receive chain 1301-1 is considered as the real samples and the samples from receive chain 1301-2 the imaginary samples. These samples are QAM demodulated by block 1304 which converts the I/Q samples to soft bits. Soft bits represent the bit stream along with a fraction which represents the distance from the constellation point.

The samples are then sent to the de-interleaver 915, which reverses the sample ordering based on the interleaver. These samples are then fed to the decoder 916 which could be a viterbi or LDPC or other decoder. The decoded bit stream is then processed by the MAC or other entity.

In other instances receive chain 1301-1 could be used to receive the imaginary samples and 1301-2 could be used to receive the real samples.

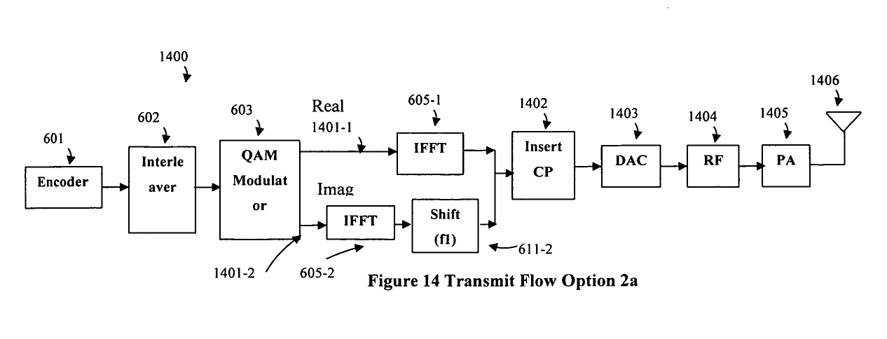

FIG. 14 describes an instantiation of the EOM modulator where the real and imaginary values obtained from the QAM modulator are transmitted over two chains. However unlike the EOM transmitter 1200 only one transmit PA is used. The imaginary value is shifted in frequency by “f1” to reduce the inter carrier spacing of the signal. The signal is encoded in 601, interleaved in 602 and then sent to the QAM modulator. One type of QAM modulator using Gray encoding of signals is described in FIG. 10. The Real samples obtained from the QAM modulator is sent over transmit chain 1401-1 and the imaginary values obtained the QAM modulator is sent over transmit chain 1401-2.

In transmit chain 1401-1, The IFFT of the signal is computed in 605-1. In transmit chain 1401-2, The IFFT of the signal is computed in 605-2, the signal is shifted by frequency “f1” by 611-2. The signals from transmit chains 1401-1 and 1401-2 are combined by adding the samples the both the chains.

Cyclic Prefix added in 1402, the digital samples converted to analogue in 1403. The RF block, 1404 modulates the signal to the RF carrier frequency and the PA, 1405 increases the signal gain. The wireless signal is then transmitted out of the antenna 1406.

In other instances transmit chain 1401-1 could be used to transmit the imaginary samples and 1401-2 could be used to transmit the real samples.

The EOM receiver 1300 as described in FIG. 13 receives and demodulates the received signal.

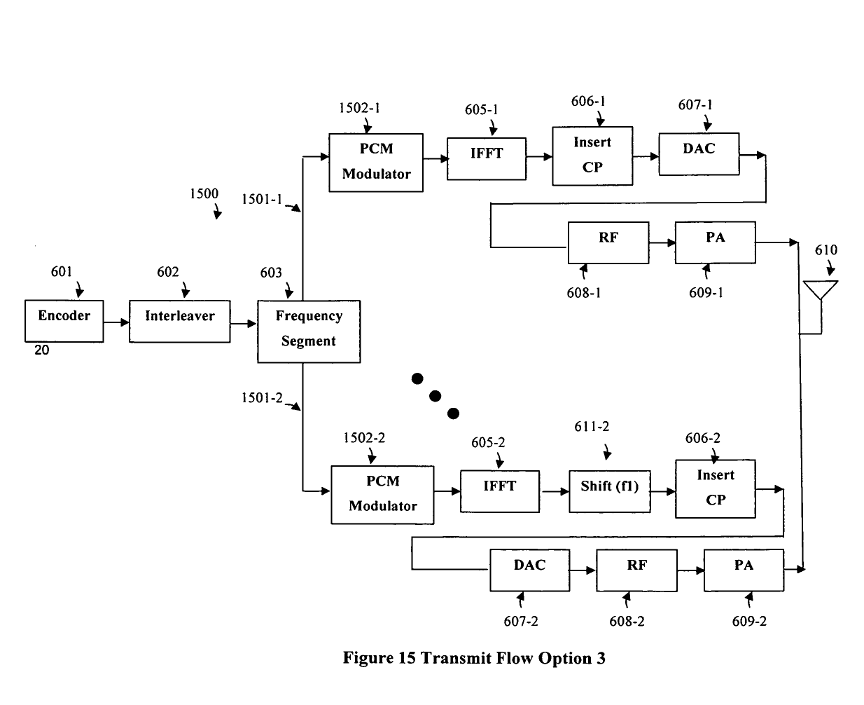

FIG. 15 shows the transmitter flow of an embodiment of the enhanced OFDM modulator 1500 where a Pulse Code Modulator (PCM) is used as a constellation Mapper. The EOM 1500 consists of an encoder 601 which could be a trellis encoder or a LDPC encoder or other encoder. The encoded bits are then sent to the interleaver 602. The output of the interleaver is sent to the Frequency segment 603. The Frequency segment takes interleaved bits and then maps them to the plurality of transmit chains 1501. The mapping of bits to the plurality of transmit chains could be done by sending the first bit to the first transmit chain, the second bit to the second transmit chain and so on. The mapping of bits could also be done where the first ‘m1’ bits are sent to the first transmit chain, the next ‘m2’ bits are sent to the next transmit chain and so on.

Other Frequency segment parsing techniques could also be used.

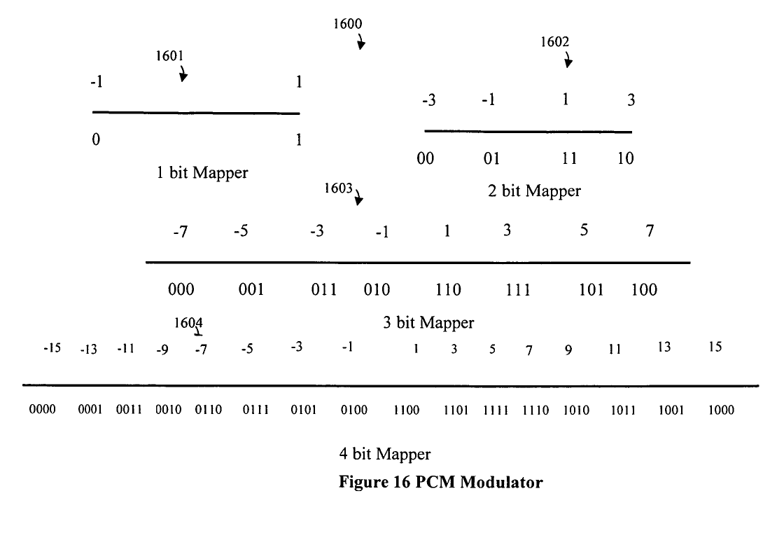

Transmit chain 1501-1 consists of a PCM modulator 1502-1. Embodiments of PCM Mappers are shown in FIG. 16. 1601 consists of a PCM mapper which maps 1 bits, 1602 which maps 2 bits, 1603 which maps 3 bits and 1604 which maps 4 bits. The PCM encoded samples are then transformed from the frequency domain to the time domain using the IFFT 605-1. Cyclic prefix is added to the bit stream in 606-1. The digital samples are then converted to analog using the Digital to Analog convertor 607-1. The baseband signal is then modulated with a carrier frequency by the RF in 608-1. The signal power is then boosted using the PA in 609-1.

Transmit chain 1502-2 consists of a PCM modulator 1502-2. Transmit chain 612-1 could use 2-level PCM modulator while transmit chain 612-2 could use 4-level PCM modulator. The samples are then transformed from the frequency domain to the time domain using the IFFT 605-2. The time domain samples are then shifted in frequency. The frequency shift is done to allow transmission of multiple streams in the same bandwidth using a single antenna. Frequency shift is applied to all N chains or (N-1) chains. Cyclic prefix is added to the bit stream in 606-2. The digital samples are then converted to analog using the Digital to Analog convertor 607-2. The baseband signal is then modulated with a carrier frequency by the RF in 608-2. The signal power is then boosted using the PA in 609-2.

The signal from all the transmit chains are combined and the wireless signal is transmitted through the antenna 610.

The increase in throughput comes from the reduction in subcarrier spacing due to multiple transmit chains and the increased transmit power from using multiple Power Amplifies (PA). A plurality of transmit chains can be combined.

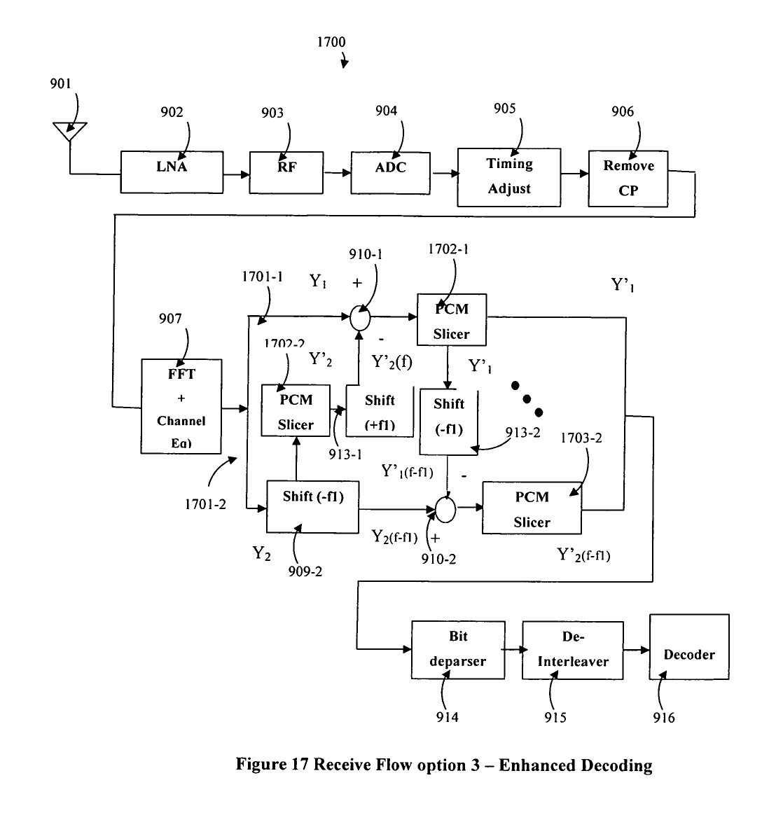

FIG. 17 describes an instance the EOM receiver which receives and demodulates signal received from the instance of the EOM transmitter 1500 in FIG. 15. The receiver 1700 consists of an antenna 901 which receives the wireless signal; the signal amplitude is increased by the LNA 902. The RF 903 converts the signal from the carrier frequency to baseband frequency. The ADC 904 converts the analog bits to digital; the timing adjustment module detects the start of the symbol and adjusts the timing of the ADC to match with the transmitter's frequency. The Cyclic prefix is removed by the Remove CP block 906. The FFT 907 computes the Fourier transform and converts the time domain signal to frequency domain. The Equalizer in 907 is used to equalize the signal.

The signal is then sent to transmit chains 1701-1 and 1702-2. In transmit chain 1702-2 the signal Y₂ is shifted by −f1 in block 909-2. The output of 909-2 is passed to the PCM Slicer 1702-2. The PCM slicer computes the nearest constellation point of the PCM constellation as described in FIG. 16.

The PCM slicer 1702-2 determines the closest constellation point corresponding to the signal and outputs that value. The modulation used could be a 1-bit, 2-bit, 3-bit or 4-bit modulation.

The output of 1702-2 is then shifted by frequency “f1” in block 913-1. The output signal Y′₂(f) is then subtracted from the signal Y₁ in transmit chain 1701-1 by 910-1. The output of 910-1 is then demodulated by PCM Slicer, 1702-1 which converts the received samples to soft bits. Soft bits represent the bit stream along with a fraction which represents the distance from the constellation point.

In transmit chain 1701-2 the signal Y₂ is shifted by −f1 in block 909-2. The shifted signal Y′₁(f−f1) is subtracted from Y₂(f−f1) in 910-2. This signal is then demodulated by PCM Slicer block 1703-2 which converts the samples to soft bits. Soft bits represent the bit stream along with a fraction which represents the distance from the constellation point.

The signals from transmit chain 1701-1 and 1701-2 are then combined in the same manner as the signal was parsed into the transmit chains by the Bit de-parser 914. The signals from transmit chain 1701-1 and 1701-2 is then combined in the same manner as the signal was parsed into the transmit chains by the Bit de-parser 914. If a round robin mechanism was used to distribute the bits over the transmit chains, a similar round robin mechanism is used to combine the bit streams from the received chains into a single bit stream. If the Frequency Segmenter Block 603 sent “m1” bits to transmit chain 612-1 and “m2” bits to transmit chain 612-2, then block 914 also first takes “m1” bits from chain 908-1 and “m2” bits from chain 908-2.

The samples are then sent to the de-interleaver 915, which reverses the sample ordering based on the interleaver. These samples are then fed to the decoder 916 which could be a viterbi or LDPC or other decoder. The decoded bit stream is then processed by the MAC or other entity.

A plurality of received chains can be combined. The number of received chains is equal to the number of transmit chains.

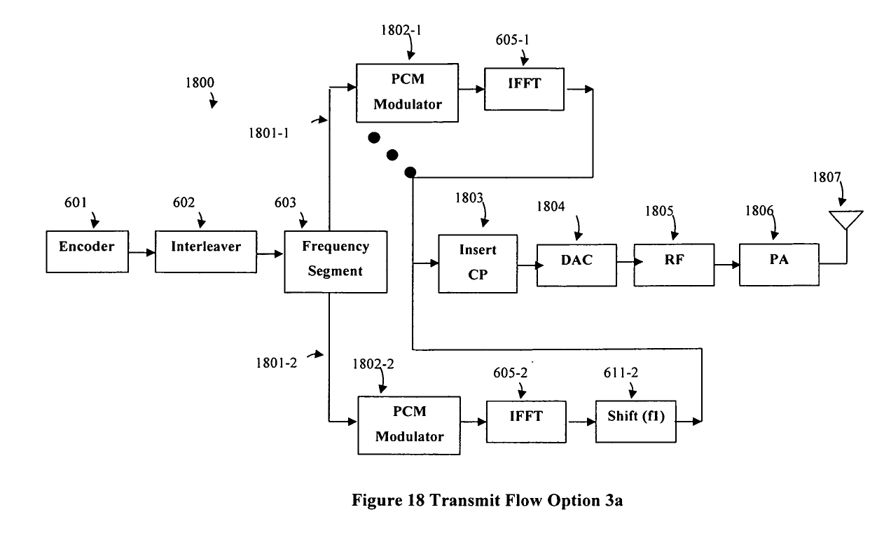

FIG. 18 describes the transmitter flow of an embodiment of the enhanced OFDM modulator 1800 which uses a single Power Amplifier instead of a Power Amplifier per transmit chain. The EOM 1800 consists of an encoder 601 which could be a trellis encoder or a LDPC encoder or other encoder. The encoded bits are then sent to the interleaver 602. The output of the interleaver is sent to the Frequency segment 603. The Frequency segment takes interleaved bits and then maps them to the plurality of transmit chains 1801. The mapping of bits to the plurality of transmit chains could be done by sending the first bit to the first transmit chain, the second bit to the second transmit chain and so on. The mapping of bits could also be done where the first ‘m1’ bits are sent to the first transmit chain, the next ‘m2’ bits are sent to the next transmit chain and so on.

Other Frequency segment parsing techniques could also be used.

Transmit chain 1801-1 consists of a PCM modulator 1802-1. Embodiments of PCM Mappers are shown in FIG. 16. The PCM encoded samples are then transformed from the frequency domain to the time domain using the IFFT 605-1.

Transmit chain 1802-2 consists of a PCM modulator 1802-2. Transmit chain 1801-1 could use 2-level PCM modulator while transmit chain 1801-2 could use 4-level PCM modulator. The samples are then transformed from the frequency domain to the time domain using the IFFT 605-2. The time domain samples are then shifted in frequency. The frequency shift is done to allow transmission of multiple streams in the same bandwidth using a single antenna. Frequency shift is applied to all N chains or (N-1) chains.

The samples from the transmit chains are then combined through addition. Cyclic prefix is added to the bit stream in 1803. The digital samples are then converted to analog using the Digital to Analog convertor 1804. The baseband signal is then modulated with a carrier frequency by the RF in 1805. The signal power is then boosted using the PA in 1806.

The wireless signal is transmitted through the antenna 1807.

The increase in throughput comes from the reduction in subcarrier spacing due to multiple transmit. A plurality of transmit chains can be combined.

The EOM receiver to demodulate signals transmitted from 1800 is described in FIG. 17.

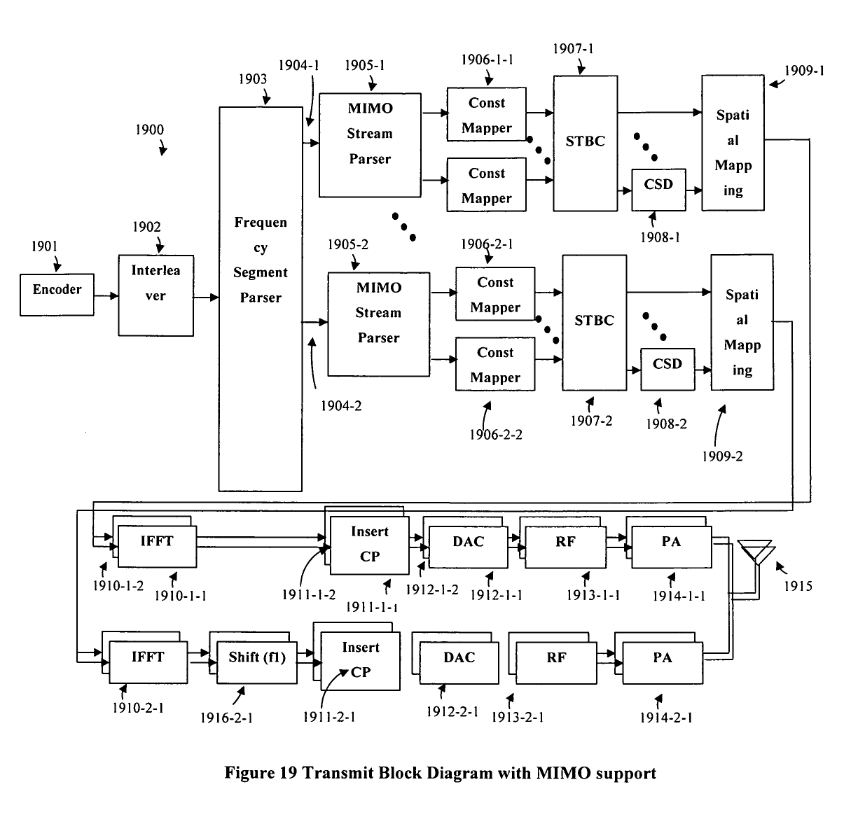

FIG. 19 describes an instantiation of the Enhanced OFDM Modulator when used with a Multiple Input Multiple Output (MIMO) transmitter. The EOM 1900 consists of an encoder 1901 which could be a trellis encoder or a LDPC encoder or other encoder. The encoded bits are then sent to the interleaver 1902. The output of the interleaver is sent to the Frequency segment 1903. The Frequency segment takes interleaved bits and then maps them to the plurality of transmit chains. The mapping of bits to the plurality of transmit chains could be done by sending the first bit to the first transmit chain, the second bit to the second transmit chain and so on. The mapping of bits could also be done where the first ‘m1’ bits are sent to the first transmit chain, the next ‘m2’ bits are sent to the next transmit chain and so on.

Other Frequency segment parsing techniques could also be used.

Transmit chain 1904-1 consists of a MIMO Stream Parser 1905-1 which are then mapped to various constellation points using the Constellation mapper in 1906-1-1. The samples are then provided to the STBC block 1907-1. The output of the STBC is if required shifted using the CSD block 1908-1. These samples are then mapped to the various RF transmit chains using the spatial mapping block 1909-1. The output of the spatial mapper are then converted from frequency domain to time domain samples through the IFFT 1910-1-1 and 1910-1-2 for the different spatial streams. Cyclic prefix is added to the bit stream in 1911-1-1 and 1911-1-2. The digital samples are then converted to analog using the Digital to Analog convertor 1912-1-1 and 1912-2. The baseband signal is then modulated with a carrier frequency by the RF in 1913-1-1. The signal power is then boosted using the PA in 1914-1-1.

Transmit chain 1904-2 consists of a MIMO Stream Parser 1905-2 which are then mapped to various constellation points using the Constellation mapper in 1906-2-1. The samples are then provided to the STBC block 1907-2. The output of the STBC is if required shifted using the CSD block 1908-2. These samples are then mapped to the various RF transmit chains using the spatial mapping block 1909-2. The output of the spatial mapper are then converted from frequency domain to time domain samples through the IFFT 1910-2-1.

The time domain samples are then shifted in frequency. The frequency shift is done to allow transmission of multiple streams in the same bandwidth. Frequency shift is applied to all N chains or (N-1) chains.

Cyclic prefix is added to the bit stream in 1911-2-1 and 1911-2-2. The digital samples are then converted to analog using the Digital to Analog convertor 1912-2-1. The baseband signal is then modulated with a carrier frequency by the RF in 1913-2-1. The signal power is then boosted using the PA in 1914-2-1.

The signal from all the transmit chains are combined and the wireless signal is transmitted through the antenna 1915.

The increase in throughput comes from the reduction in subcarrier spacing due to multiple transmit. A plurality of transmit chains can be combined.

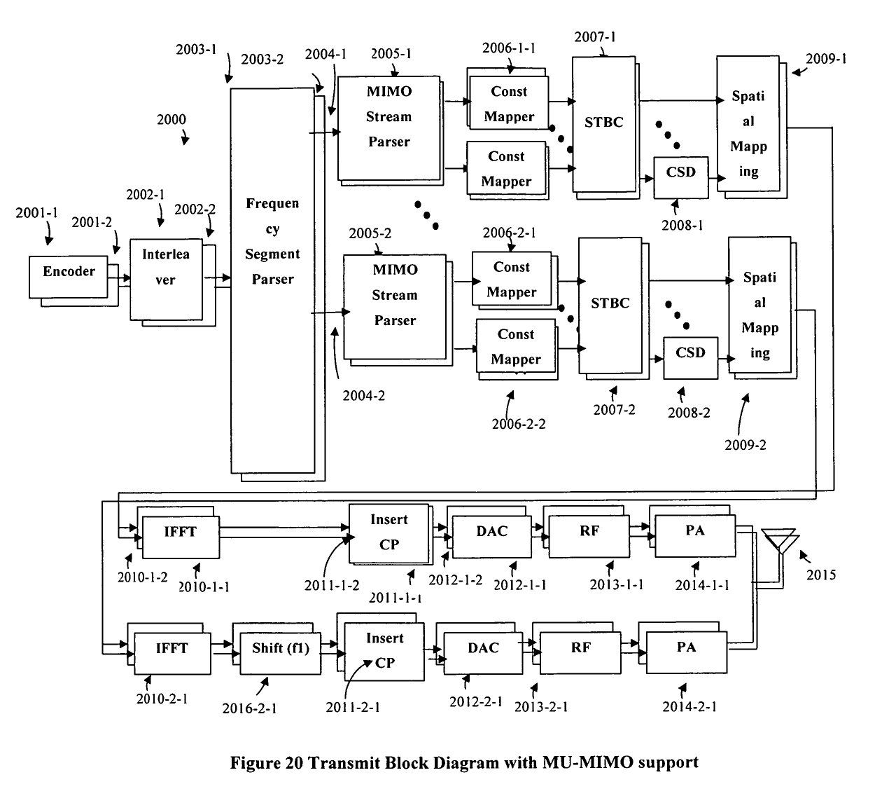

FIG. 20 describes an instantiation of the Enhanced OFDM Modulator when used with a Multi-User Multiple Input Multiple Output (MIMO) transmitter. The EOM 2000 describes the transmit chain when data is transmitted to two users. The transmit chain consists of encoders 2001-1 and 2001-2 which encode the bit stream per user. The encoders could be a trellis encoder or a LDPC encoder or other encoder. The encoded bits are then sent to the interleavers 2002-1 and 2002-2. The output of the interleaver is sent to the Frequency segment 2003-1 and 2003-2. The Frequency segment takes interleaved bits and then maps them to the plurality of transmit chains. The mapping of bits to the plurality of transmit chains could be done by sending the first bit to the first transmit chain, the second bit to the second transmit chain and so on. The mapping of bits could also be done where the first ‘m1’ bits are sent to the first transmit chain, the next ‘m2’ bits are sent to the next transmit chain and so on.

Other Frequency segment parsing techniques could also be used.

Transmit chain 2004-1 consists of a MIMO Stream Parser 2005-1 which are then mapped to various constellation points using the Constellation mapper in 2006-1-1. The samples are then provided to the STBC block 2007-1. The output of the STBC is if required shifted using the CSD block 2008-1. These samples are then mapped to the various RF transmit chains using the spatial mapping block 2009-1. The output of the spatial mapper are then converted from frequency domain to time domain samples through the IFFT 2010-1-1 and 2010-1-2 for the different spatial streams. Cyclic prefix is added to the bit stream in 2011-1-1 and 2011-1-2. The digital samples are then converted to analog using the Digital to Analog convertor 2012-1-1 and 2012-2. The baseband signal is then modulated with a carrier frequency by the RF in 2013-1-1. The signal power is then boosted using the PA in 2014-1-1.

Transmit chain 2004-2 consists of a MIMO Stream Parser 2005-2 which are then mapped to various constellation points using the Constellation mapper in 2006-2-1. The samples are then provided to the STBC block 2007-2. The output of the STBC is if required shifted using the CSD block 2008-2. These samples are then mapped to the various RF transmit chains using the spatial mapping block 2009-2. The output of the spatial mapper are then converted from frequency domain to time domain samples through the IFFT 2010-2-1.

The time domain samples are then shifted in frequency. The frequency shift is done to allow transmission of multiple streams in the same bandwidth. Frequency shift is applied to all N chains or (N-1) chains.

Cyclic prefix is added to the bit stream in 2011-2-1 and 2011-2-2. The digital samples are then converted to analog using the Digital to Analog convertor 2012-2-1. The baseband signal is then modulated with a carrier frequency by the RF in 2013-2-1. The signal power is then boosted using the PA in 2014-2-1.

The signal from all the transmit chains are combined and the wireless signal is transmitted through the antenna 2015.

The increase in throughput comes from the reduction in subcarrier spacing due to multiple transmit. A plurality of transmit chains can be combined. Data can be transmitted to a plurality of wireless clients.

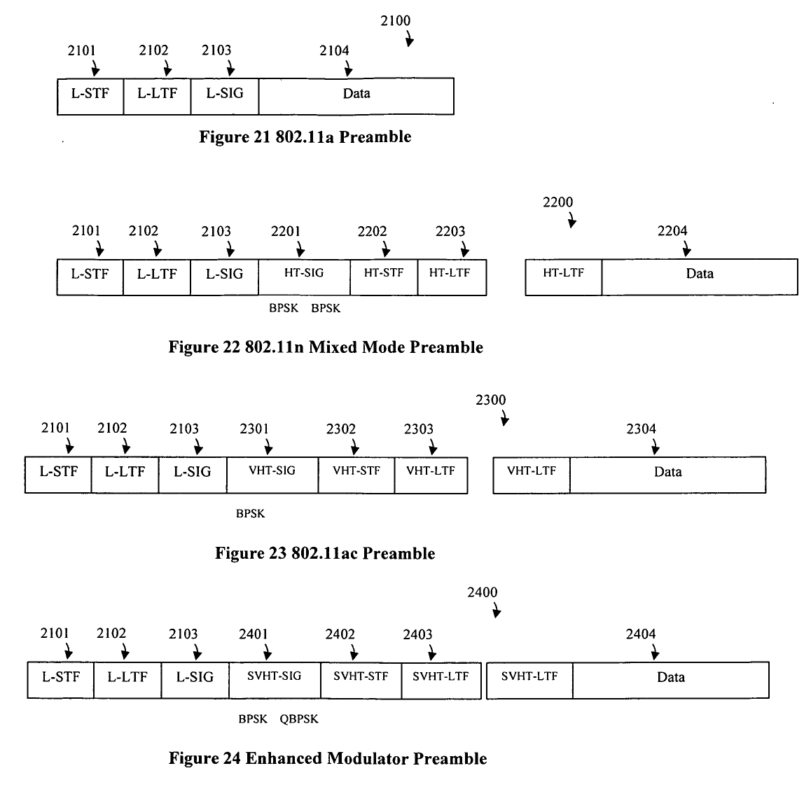

FIG. 21 describes the IEEE 802.11a preamble. The L-STF 2101 is the short training field, the L-LTF 2102 is the long training field, the L-SIG 2103 contains header information to decode the data. The data is contained in 2104.

FIG. 22 describes the IEEE 802.11n Mixed mode preamble. The L-STF 2101 is the short training field, the L-LTF 2102 is the long training field, the L-SIG 2103 contains legacy header information. The HT-SIG 2201 contains information to decode the data. This is followed by the HT short training field HT-STF 2202 and the HT long training field 2203. This is followed by the data is contained in 2204.

FIG. 23 describes the IEEE 802.11ac preamble. The L-STF 2101 is the short training field, the L-LTF 2102 is the long training field, the L-SIG 2103 contains legacy header information. The VHT-SIG 2301 contains information to decode the data. This is followed by the VHT short training field, VHT-STF 2302 and the VHT long training field 2303. This is followed by the data is contained in 2304.

FIG. 24 describes the Enhanced Modulator preamble when used in an IEEE 802.11 system. The L-STF 2101 is the short training field, the L-LTF 2102 is the long training field, the L-SIG 2103 contains legacy header information. The SVHT-SIG 2401 contains information to decode the data. This is followed by the SVHT short training field, SVHT-STF 2402 and the SVHT long training field 2403. This is followed by the data is contained in 2404. The packet header indicates the frequency shift applied at the transmitter. This could be indicated in the legacy packet header or in the SVHT part of the packet header.

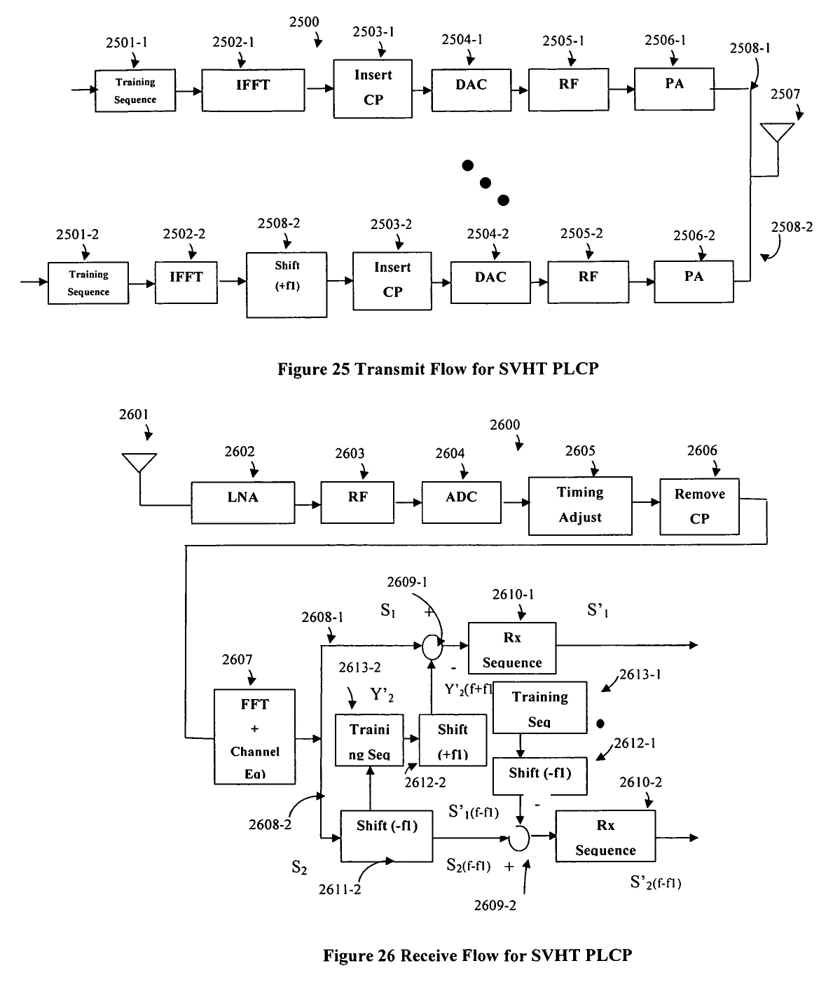

FIG. 25 describes the transmitter flow of an embodiment of the enhanced OFDM modulator which is used to transmit the preamble 2400 as described in FIG. 24. The EOM Preamble transmitter 2500 consists of the multiple transmit chains 2508-1 and 2508-2.

Transmit chain 2508-1 includes a block to generate the training sequence 2501-1. The training sequence is then transformed from the frequency domain to the time domain using the IFFT 2502-1. Cyclic prefix is added to the bit stream in 2503-1. The digital samples are then converted to analog using the Digital to Analog convertor 2504-1. The baseband signal is then modulated with a carrier frequency by the RF in 2505-1. The signal power is then boosted using the PA in 2506-1.

Transmit chain 2508-2 includes a block to generate the training sequence 2501-1. The training sequence is then transformed from the frequency domain to the time domain using the IFFT 2502-1. The time domain samples are then shifted in frequency by 2508-2. The frequency shift is done to allow transmission of multiple streams in the same bandwidth using a single antenna. Frequency shift is applied to all N chains or (N-1) chains. Cyclic prefix is added to the bit stream in 2503-2. The digital samples are then converted to analog using the Digital to Analog convertor 2504-2. The baseband signal is then modulated with a carrier frequency by the RF in 2505-2. The signal power is then boosted using the PA in 2506-2.

The signal from all the transmit chains are combined and the wireless signal is transmitted through the antenna 2507.

The increase in throughput comes from the reduction in subcarrier spacing due to multiple transmit. A plurality of transmit chains can be combined.

FIG. 26 describes the receiver flow of an embodiment of the enhanced OFDM receiver which is used to receive the preamble 2400 as described in FIG. 24.

The receiver 2600 consists of an antenna 2601 which receives the wireless signal; the signal amplitude is increased by the LNA 2602. The RF 2603 converts the signal from the carrier frequency to baseband frequency. The ADC 2604 converts the analog bits to digital; the timing adjustment module detects the start of the symbol and adjusts the timing of the ADC to match with the transmitter's frequency. The Cyclic prefix is removed by the Remove CP block 2606. The FFT 2607 computes the Fourier transform and converts the time domain signal to frequency domain. The Equalizer in 2607 is used to equalize the signal.

The signal is then sent to transmit chains 2608-1 and 2608-2. In transmit chain 2608-2 the signal S₂ is shifted by −f1 in block 2611-2. The output of 2611-2 is passed to the Training Sequence block 2613-2. The Training Sequence block 2613-2 computes the nearest Training Sequence value based on the received signal.

The output of 2613-2 is then shifted by frequency “f1” in block 2612-2. The output signal Y′₂(f+f1) is then subtracted from the signal S₁ in transmit chain 2608-1 by 2609-1. The output of 2609-1 is the receive sequence for receive chain 2608-1 represented by S′₁.

In transmit chain 2608-2 the signal S₂ is shifted by −f1 in block 2611-2. The shifted signal S′₁(f−f1) is subtracted from S₂(f−f1) in 2609-2. The output of 2610-2 is the receive sequence for receive chain 2608-2 represented by S′₂(f−f1).

A plurality of received chains can be used to receive the training signal. The number of received chains is equal to the number of transmit chains.

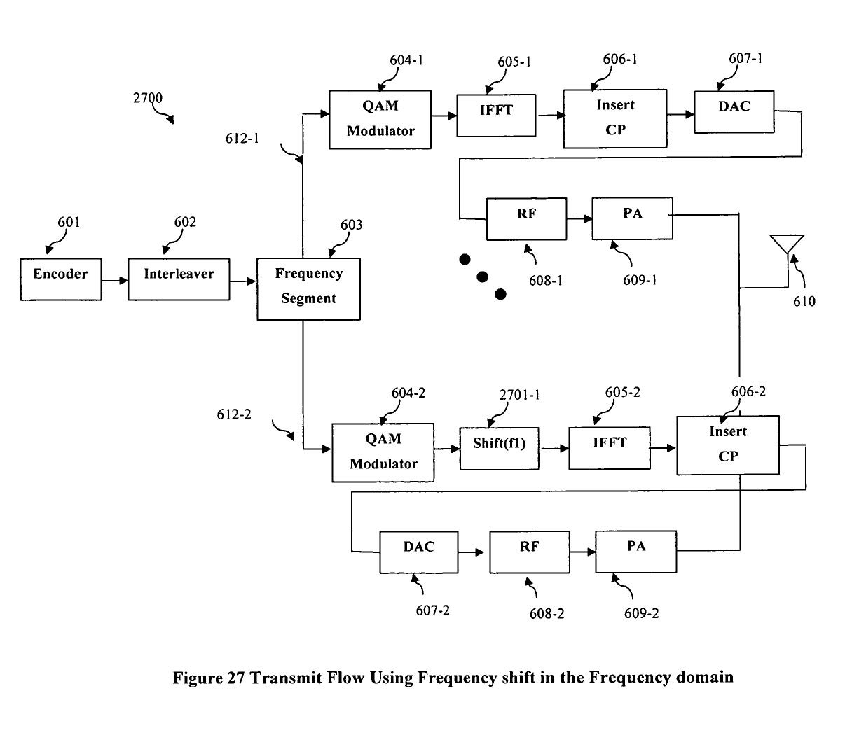

FIG. 27 describes an embodiment of the EOM transmitter where the frequency shift is done in the frequency domain instead of the time domain.

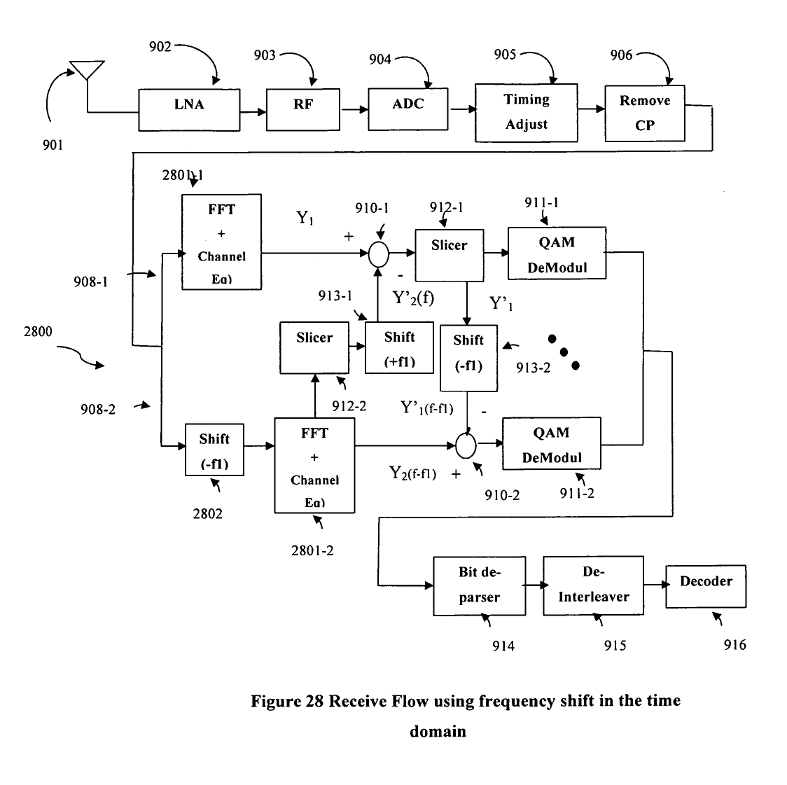

Similarly FIG. 28 describes an embodiment of the EOM receiver where the frequency shift is done in the time domain instead of the frequency domain.

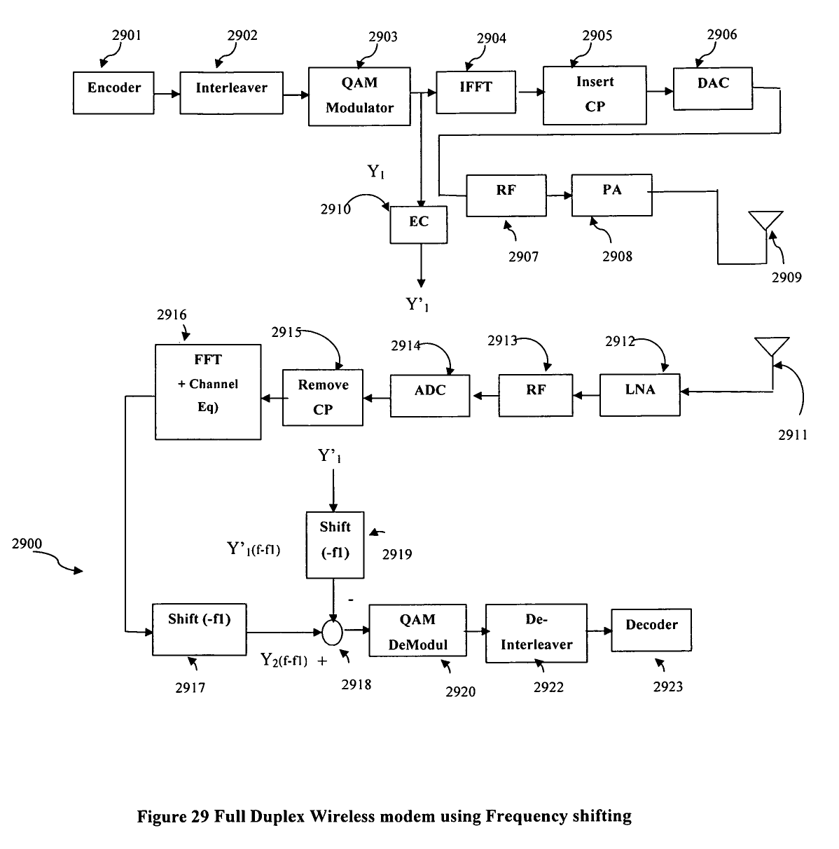

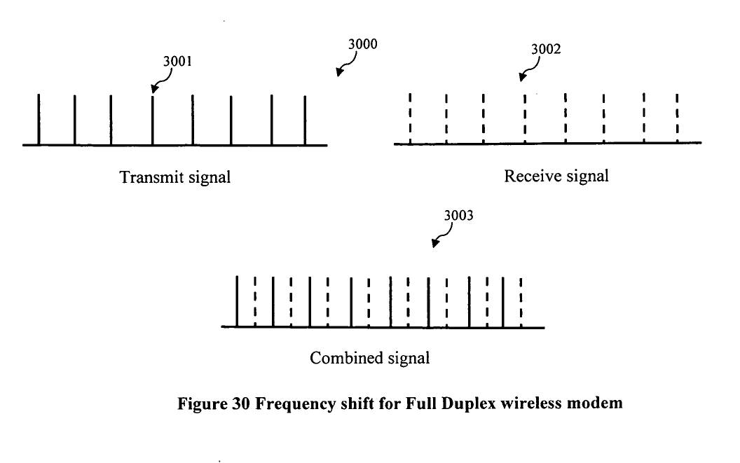

FIG. 29 describes the modulator flow of an embodiment of the enhanced OFDM modulator which is capable of Full Duplex wireless transmission and reception. The wireless modem in 2900 transmits and receives wireless signals on the same channel frequency simultaneously. Effective transmit to receive cancellation can be achieved by using separate antennas, an echo canceller and separating transmit and receive frequencies by shifting them in frequency such that the sub-carriers of the receive align within the inter carrier spacing as shown in FIG. 30.

The EOM 2900 consists of an encoder 2901 which could be a trellis encoder or a LDPC encoder or other encoder. The encoded bits are then sent to the interleaver 2902. The QAM modulator 2903 could use Gray encoding to map the bits to real and imaginary values. Typical QAM modulators are BPSK, QPSK, 16-QAM, 64-QAM and 256-QAM. Other QAM modulators could also be used. The real and imaginary samples are then transformed from the frequency domain to the time domain using the IFFT 2904. Cyclic prefix is added to the bit stream in 2905. The digital samples are then converted to analog using the Digital to Analog convertor 2906. The baseband signal is then modulated with a carrier frequency by the RF in 2907. The signal power is then boosted using the PA in 2908. Finally the wireless signal is transmitted through the antenna 2909.

The receiver in EOM 2900 consists of an antenna 2911 which receives the wireless signal; the signal amplitude is increased by the LNA 2912. The RF 2913 converts the signal from the carrier frequency to baseband frequency. The ADC 2914 converts the analog bits to digital; the Cyclic prefix is removed by the Remove CP block 2915. The FFT 2916 computes the Fourier transform and converts the time domain signal to frequency domain. The Equalizer in 2916 is used to equalize the signal. The signal is then shifted by frequency “−f1” in block 2917.

The output of the QAM modulator of the transmitter is sent to the Echo canceller which converts the transmit signal to best represent the received echo. This signal The output signal Y′₂(f−f1) is then subtracted from the signal is then shifted by frequency “−f1”. The shifted signal Y′₁(f−f1) is subtracted from Y₂(f−f1) in 2918. This signal is then QAM demodulated by block 2920 which converts the I/Q samples to soft bits. Soft bits represent the bit stream along with a fraction which represents the distance from the constellation point. The samples are then de-interleaved in 2922 and decoded in 2923. The decoded bit stream is then processed by the MAC or other entity.

Effective Full Duplex Wireless transmission is possible as the transmit and receive sub carriers are separated by the frequency shift. The frequency shift could similarly be applied by the wireless transmitter.

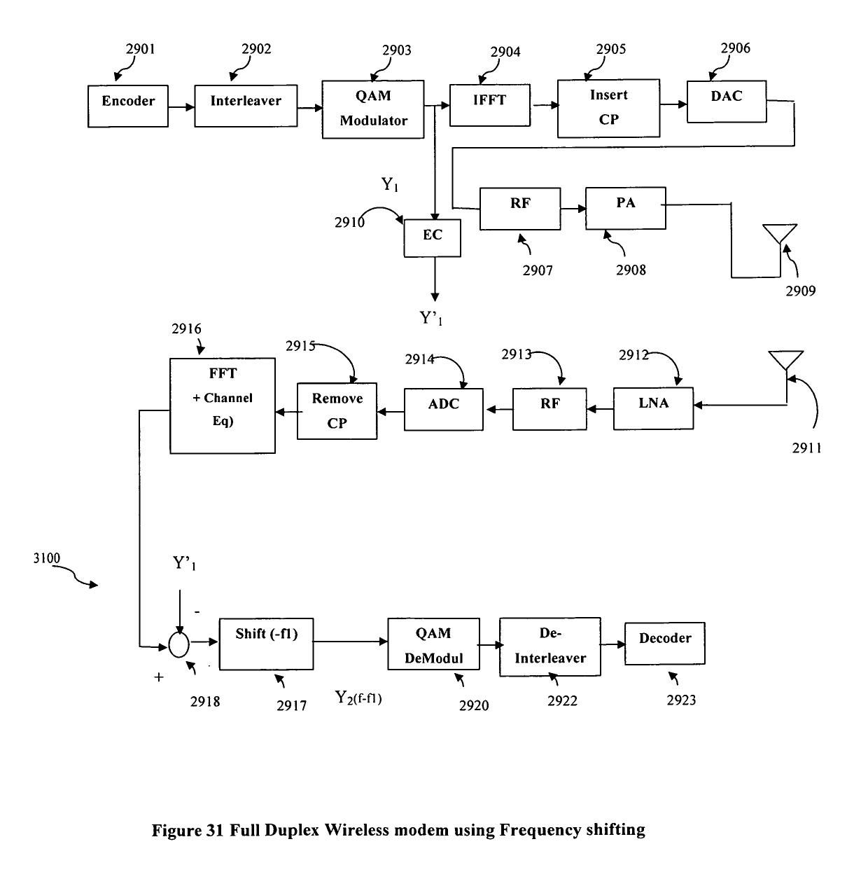

FIG. 31 illustrates the embodiment of the Full Duplex modem where the echo is removed prior to shifting of the signal in the receiver path.

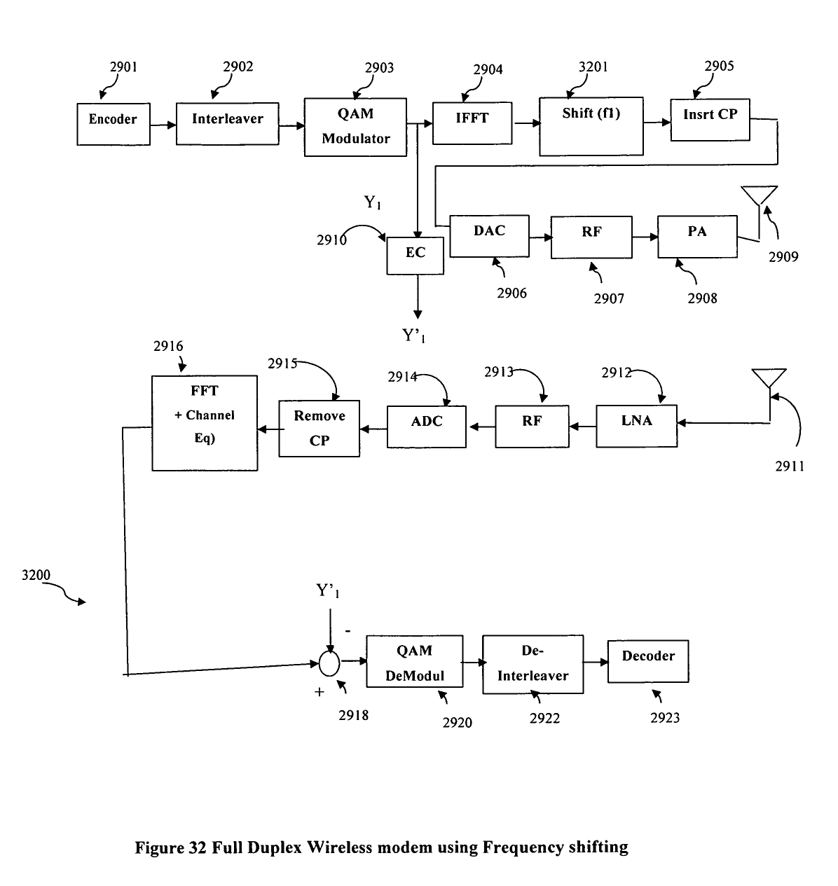

FIG. 32 illustrates the embodiment of the Full Duplex modem where the frequency shift is applied on the transmitter.

With sufficient isolation both the transmit and the receive could use the same antenna.

What is claimed is:

1. An apparatus comprising of a transmit circuit capable of generating a plurality of baseband signals indicative of one or more symbols; shifting some or all of the baseband signals so that they occupy different frequencies and then combining the signals, RF modulating the signal; transmitting the modulated communication signal;

2. An apparatus comprising of a receive circuit capable of; demodulating the received signal using a plurality of demodulators; shifting the demodulated signal; subtracting the received demodulated signal from one receive path to the other; further demodulating the signal on the plurality of received chains; combining the signal received from the plurality of received chains to reconstruct the data.

3. An apparatus comprising of a full duplex transmit circuit and receive circuit wherein the signal on one of the paths is shifted in frequency and an echo canceller is used to subtract the echo from the received signal.

4. The apparatus of claim 1, wherein the plurality of baseband signal is generated by using a circuit which generates signals for each of the transmit circuit and wherein the signal on a plurality of the transmit circuit is shifted in frequency.

5. The apparatus of claim 1, wherein the signal from the plurality of transmit circuit is transmitted using a plurality of power amplifiers or a single power amplifier and transmitted using transmit antenna.

6. The apparatus of claim 1, wherein a Quadrature Amplitude Modulator is used to modulate the signal.

7. The apparatus of claim 1, where in a Pulse Code Modulator is used to modulate the signal.

8. The apparatus of claim 1, wherein generating the baseband signal comprises generating orthogonal frequency division multiplexed (OFDM) signal.

9. The apparatus of claim 1, wherein the generated baseband signal comprises generating MIMO OFDM signal.

10. The apparatus of claim 1, wherein the generated baseband signal comprises generating Multi-user MIMO OFDM signal.

11. The apparatus of claim 1, wherein different frequency shifts are applied for different users of the Multi-user MIMO OFDM system.

12. A method of claim 1, to indicate the presence of the enhanced modulation scheme in the preamble of IEEE 802.11 packet header where the initial part of the packet header includes indication required for legacy receivers followed by a field to indicate the presence of enhanced modulation transmission.

13. A method of claim 1, wherein the packet header indicates frequency shift applied at the transmitter.

14. The apparatus of claim 2, wherein a Quadrature Amplitude de-Modulation is used to de-modulate the signal.

15. The apparatus of claim 2, wherein a Pulse Code de-Modulation is used to de-modulate the signal.

16. The apparatus of claim 2, wherein a circuit is used to combine the demodulated signal from the plurality of receive circuits, wherein the signal on one or more of the receive circuit is shifted in frequency.

17. The apparatus of claim 2, wherein the received baseband signal comprises of orthogonal frequency division multiplexed (OFDM) signal.

18. The apparatus of claim 2, wherein the received baseband signal comprises of receiving MIMO OFDM signal.

19. The apparatus of claim 2, wherein the received baseband signal comprises of receiving Multi-user MIMO OFDM signal wherein one or more of the receive circuit corresponding to the Multi-user reception is shifted in frequency.

20. The apparatus of claim 3; wherein transceiver A communicates using Full duplex communication to transceiver B. The signal transmitted by transceiver A is shifted in frequency by the transmit circuit of the wireless modem A. The transmitted signal from transceiver B is passed through an echo canceller circuit which estimates the received echo and then shifted in frequency and then removed from the received signal which is also shifted in frequency at the receive circuit of transceiver B.

21. The apparatus of claim 3; wherein transceiver A communicates using Full duplex communication to transceiver B. The signal transmitted by transceiver A is shifted in frequency by the transmit circuit of the wireless modem A. The transmitted signal from transceiver B is passed through an echo canceller circuit which estimates the received echo and then removed from the receive signal in the receive circuit of transceiver B. The signal is then shifted in frequency at the receive circuit of transceiver B.

22. The apparatus of claim 3; wherein transceiver A communicates using Full duplex communication to transceiver B. The signal transmitted by transceiver B is shifted in frequency by the transmit circuit of the wireless modem B. The transmitted signal from transceiver A is passed through an echo canceller circuit which estimates the received echo and then removed from the receive signal in the receive circuit of transceiver A. The signal is then shifted in frequency at the receive circuit of transceiver A.

23. The apparatus of claim 3; wherein transceiver A communicates using Full duplex communication to transceiver B. The signal transmitted by transceiver B is shifted in frequency by the transmit circuit of the wireless modem B. The transmitted signal from transceiver A is passed through an echo canceller circuit which estimates the received echo and then shifted in frequency. The signal received by the receive circuit of transceiver A is also shifted in frequency. The shifted echo is then removed from the shifted receive signal in the receive circuit of transceiver A.

24. A method of claim 3, to indicate the presence of the enhanced modulation scheme in the preamble of IEEE 802.11 packet header where the initial part of the packet header includes indication required for legacy receivers followed by a field to indicate the presence of enhanced modulation transmission.

25. A method of claim 3, wherein the packet header indicates frequency shift applied at the transmitter.
